(19) United States
(12) Patent Application Publication
(10) Pub. No.: US 2017/0334142 A1
(43) Pub. Date: Nov. 23, 2017

(54) METHOD FOR THREE-DIMENSIONAL PRINTING

(71) Applicants: Universite Grenoble Alpes, Saint Martin D'Heres (FR); Centre National de la Recherche Scientifique, Paris Cedex 16 (FR)

(72) Inventors: Patrice Baldeck, Vizille (FR); Kevin John Heggarty, Lanrivoare (FR)

(73) Assignees: Universite Grenoble Alpes, Saint Martin D'Heres (FR); Centre National de la Recherche Scientifique, Paris Cedex 16 (FR)

(21) Appl. No.: 15/522,271

(22) PCT Filed: Oct. 21, 2015
(86) PCT No.: PCT/FR2015/052831

§ 371 Date: Apr. 26, 2017

(30) Foreign Application Priority Data
Oct. 27, 2014 (FR) 1460282

(51) Int. Cl. B29C 64/386; B33Y 10/00; B33Y 50/02; B29C 64/135

(52) U.S. Cl. CPC B29C 64/386; B29C 64/135; B33Y 10/00; B33Y 50/02

(57) ABSTRACT

A method for 3D printing, wherein elementary volumes, or voxels, of a material are sequentially transformed by irradiation, including the following steps: breaking down, into identical blocks, the volume of part of an object to be printed that does not require a maximum resolution; for printing, associating with each block a brick having the same contour and comprising hollow portions; and irradiating in order to print the voxels of the bricks.

The present patent application claims the priority benefit of French patent application FR14/60282 which will be incorporated herein by reference.

### BACKGROUND

The present application relates to a method of three-dimensional (3D) printing, more currently called 3D printing, where elementary volumes, or voxels, of a material are successively transformed by irradiation.

### DISCUSSION OF THE RELATED ART

A known 3D printing method based on successive transformations of elementary volumes of a material by irradiation uses a chemical reaction induced by multiphoton absorption involving at least two photons. A printer implementing such a method is currently called two-photon absorption 3D printer.

FIG. 1 schematically shows an example of a two-photon absorption 3D printer. The 3D printer successively comprises, on an optical axis 1, a laser source 3, a beam magnifier 5, a planar mirror 7, a diaphragm 11, and a focusing lens 13. In the shown example, beam magnifier 5 comprises two lenses 5A and 5B. A tray 15 filled with a photosensitive material 17 rests on a XYZ table 19 capable of being displaced along directions orthogonal (XY) and parallel (Z) to the propagation direction of a laser beam 21 generated by source 3, and capable of optionally rotating along rotation axes X, Y, and Z. Photosensitive material 17 may comprise a resin solidifying by polymerization or photocrosslinking, a resin having its solubility properties modified by photochemistry, proteins solidifying by photocros slinking, or metal salts solidifying by photocrosslinking. The case where the material is a resin solidifying by photocrosslinking is considered hereafter as an example.

In operation, laser beam 21 is focused by lens 13 into a point 23 located in material 17. At focusing point 23, when the power of the laser is sufficient, an elementary volume of material 17 is transformed and solidifies. In FIG. 1, point 23 is shown as being at the bottom of tray 15. XYZ table 19 is controlled so that focusing point 23 of beam 21 is displaced into material 17 to form other voxels until the entire volume of the object to be printed has solidified, the excess non-transformed material being for example dissolved by an appropriate solvent.

FIG. 2 is a cross-section view schematically illustrating the shape of the focusing area of laser beam 21. At the level of its focusing point 23, laser beam 21 has an area of maximum convergence for which the beam has a minimum diameter (waist) D_{MIN}. The beam diameter increases as the distance to the area of maximum convergence increases. In particular, at a distance L_{R} (Rayleigh length) to the area of maximum convergence, the energy per surface area unit of the laser beam is equal to half the energy per surface area unit at the level of the area of maximum convergence.

Call focal volume 25 the volume portion of laser beam 21 centered on the area of maximum convergence and having a length L equal to twice Rayleigh length L_{R}. As an example, it is considered hereafter that focal volume 25 corresponds to the volume portion of laser beam 21 where the energy per surface area unit of beam 21 is sufficient to induce a photochemical two-photon absorption reaction causing the forming of a voxel of same dimensions Dₘᵢₙ and L as focal volume 25, L then designating the height of a voxel. In practice, according to the intensity of the incident laser beam and the time of exposure of the photosensitive material to the beam, a voxel of solid material having a volume different from that of the focal volume can be obtained. For example, a voxel may have substantially the shape of an olive of diameter Dₘᵢₙ and of height L. It can be shown that L is proportional to the square of D_{MIN} As an example, for Dₘᵢₙ=0.25 μm, L=0.7 μm. When multiplying by 100 dimension Dₘᵢₙ, the value of L is multiplied by 10,000, that is, extremely stretched voxels are obtained (Dₘᵢₙ=25 μm and L=7 mm in this example). The depth resolution is then insufficient to print a 3D object, even with a millimeter-range resolution.

Two-photon absorption 3D printers have thus been essentially developed for the manufacturing of objects requiring a high resolution in the order of one micrometer, or even of some hundred nanometers, and are generally used for the manufacturing of objects having dimensions smaller than one millimeter.

FIGS. 3A and 3B schematically show an example of an object to be printed in 3D, FIG. 3A being a top view of the object and FIG. 3B being a cross-section view along a plane BB of FIG. 3A. The object to be printed is a filter 31 comprising a filter mesh 33 forming one piece with a ring 35. The mesh, or sieve, 33 comprises extremely fine patterns which should be formed with a high resolution while ring 35 does not require a very high resolution.

Grid 33 comprises an array of bars 37 of small dimensions having, for example, a 0.1-μm width with an interval between bars of 0.2 μm. Ring 35, which is square-shaped, for example has a 0.6-cm height, a 0.4-cm thickness, and a 0.8-cm inner diameter.

If filter 31 is desired to be formed with the 3D printer of FIG. 1, one will have, in order to print grid 33 with the desired accuracy, to select a printer such that the voxels have dimensions smaller than or equal to some hundred nanometers, whereby, to print ring 35 of millimeter-range dimensions at least 10,000 times larger than those of the voxels, printing times become very long.

There thus is a need for a method of 3D printing by successive irradiations of a material which enables to decrease the printing times of objects comprising portions to be printed with a high resolution and portions which can be printed with a lower resolution, for example, at least 100 times lower.

### SUMMARY

Thus, an embodiment provides a 3D printing method, where elementary volumes, or voxels, of a material are sequentially transformed by irradiation, comprising the steps of: breaking down the volume of a portion of an object to be printed which does not require a maximum resolution into identical blocks; for the printing, associating with each block a brick of same contour comprising hollow portions; and irradiating to print the voxels of the bricks.

According to an embodiment, a succession of irradiations is carried out, each irradiation providing an array of irradiation beams focused into an array of points distributed in the material in the same way for two successive irradiations, the array of points being offset in the material between two successive irradiations.

According to an embodiment, during certain irradiations, certain beams are inhibited.

According to an embodiment, the array of points is offset in the material by the displacement of a tray filled with the material.

According to an embodiment, the array of points is offset in the material by a quantity smaller than the dimensions of a voxel.

According to an embodiment, the array of points corresponds to an array of voxels, each of which is located at a given position of a different brick.

According to an embodiment, the array of points corresponds to an array of voxels, each of which is located at a given position of a same brick.

According to an embodiment, the transformation of a voxel results from a photochemical reaction induced by absorption of two photons.

According to an embodiment, the dimensions of said blocks are at least 100 times greater than those of the voxels.

According to an embodiment, the portion which does not require the maximum resolution has dimensions at least 100 times greater than the maximum resolution.

### BRIEF DESCRIPTION OF THE DRAWINGS

The foregoing and other features and advantages will be discussed in detail in the following non-limiting description of specific embodiments in connection with the accompanying drawings, among which:

FIG. 1, previously described, is a simplified representation of an example of a two-photon absorption 3D printer;

FIG. 2, previously described, schematically illustrates the shape of a laser beam at the level of its focusing point;

FIGS. 3A and 3B, previously described, schematically show an example of a 3D object to be printed;

FIG. 4 schematically illustrates a step of an embodiment of a 3D printing method;

FIGS. 5A to 5C schematically show different embodiments of a 3D printing method;

FIG. 6 is a simplified representation of another example of a two-photon absorption 3D printer; and

FIGS. 7A to 7E schematically illustrates steps of an embodiment of a 3D printing method.

For clarity, the same elements have been designated with the same reference numerals in the various drawings and, further, the various drawings are not to scale.

### DETAILED DESCRIPTION

A 3D printing method where the portions of a 3D object having dimensions much larger than those of a voxel are printed from voxel bricks comprising hollow portions is here provided.

In the following description, terms referring to directions, such as “on”, “lateral”, “upper”, “lower”, “left-hand”, “right-hand”, etc., apply to devices arranged as illustrated in the corresponding cross-section views, it being understood that, in practice, the devices may have different directions.

In an initial step of analysis of the object to be printed, the portions of this object requiring to be printed with a high resolution and the portions of this object which can be printed with a lower resolution are identified, the latter having dimensions much larger than those of the portions requiring a high resolution, for example, from 100 to 1,000 times larger, or even more than 10,000 larger. For example, for filter 31, gate 35 should be printed with a high resolution in the order of some hundred nanometers, and the 3D printer is selected so that diameter Dₘᵢₙ and height L of the voxels are for example equal to 0.1 μm and to 0.3 μm. A lower resolution, for example, in the order of one millimeter, may be selected to print ring 35, and the dimensions of the focal volume, and thus of the voxels, may then be increased by using a focusing lens of lower resolution so that diameter Dₘᵢₙ and height L of the voxels are for example equal to 1 μm and to 10 μm.

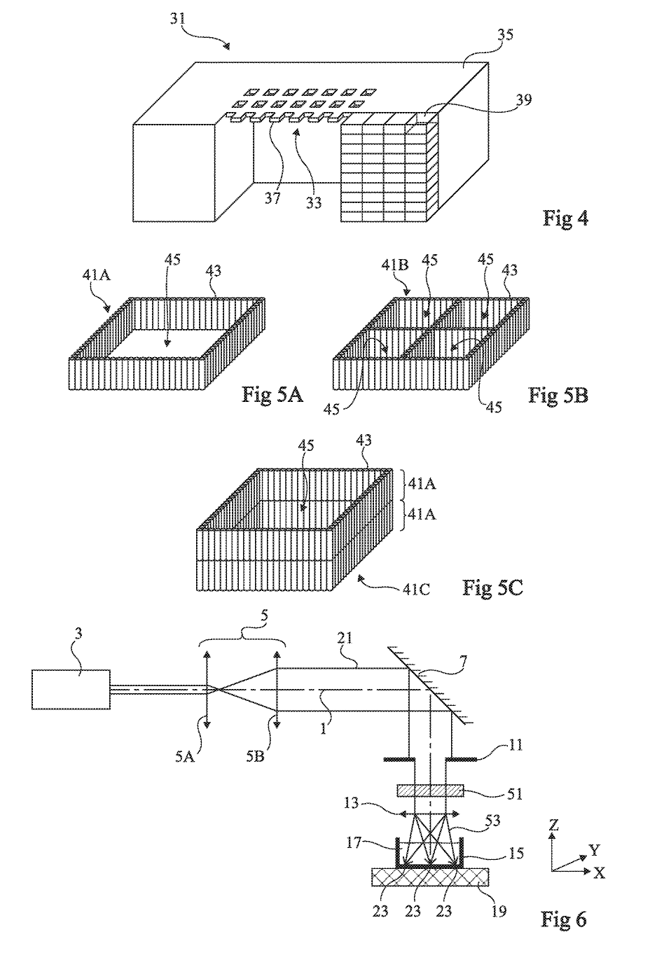

FIG. 4 is a simplified perspective cross-section view of filter 31 along plane BB of FIG. 3A. The volume of the portions which do not require being printed with a high resolution, here the volume of ring 35, is broken down into identical blocks 39. The lateral dimensions of blocks 39 are selected to be larger, for example, at least 10 times larger, and preferably at least from 100 to 1,000 times larger, than those of the voxels used for the printing thereof. For clarity, only a few blocks 39 resulting from such a breakdown have been shown, on the right-hand side of the drawing. In this example, blocks 39 are cuboids for example having side lengths of approximately 1 mm and a 10-μm height equal to height L of the voxels used to print them.

To manufacture portions of an object to be printed which does not require a high resolution, a voxel brick of same contour and comprising one or a plurality of hollow portions is printed for each block 39. Each brick is formed by printing, for example, successively, each of the voxels forming it.

According to a variation, it is possible to only print voxel bricks at the level of the surface of the portions which do not require being printed with a high resolution, across a thickness sufficient to provide a good mechanical stiffness of these parts.

It may further be provided to form a tight layer covering the outer surfaces of a given volume.

FIGS. 5A, 5B, and 5C are perspective views schematically illustrating examples of voxel bricks comprising one or a plurality of hollow portions. In these drawings, voxels 43 are not drawn to scale and, in practice, each brick comprises a number of voxels much larger than that shown in the drawings.

In FIG. 5A, brick 41A is defined by a contour of voxels 43 corresponding to its perimeter. In this example, each of the upper and lower sides of the brick comprises a number m of voxels, and each of the right-hand and left-hand sides of the brick comprises a number n of voxels.

In FIG. 5B, brick 41B further comprises a median cross-brace.

In FIG. 5C, brick 41C comprises two bricks 41A stacked on each other.

As shown in FIGS. 5A to 5C, each voxel 43 may partly penetrate into its neighboring voxels 43, which enables to increase the mechanical stability of the brick. It should be understood that, although voxel bricks 43 comprising voxel lines formed of a single voxel row have been shown, in alternative embodiments, the voxel lines may comprise a plurality of voxel rows.

It can be seen in FIGS. 5A to 5C that each of bricks 41A, 41B, and 41C comprises in its central portion one or a plurality of hollow portions 45 where no voxel is formed. Conversely to prior art 3D printing methods where a large number of voxels 43 would be printed to entirely fill each volume corresponding to a block 39, in the method described herein, voxels are only printed in the solid portions of each brick corresponding to a block 39. Thus, the number of printed voxels is much smaller, whereby the printing times of ring 35 and thus of filter 31 are greatly decreased.

As previously mentioned, the voxels forming bricks 41A, 41B, and 41C may be printed one after the other. The inventors also provide simultaneously printing a plurality of voxels.

FIG. 6 schematically shows another example of a two-photon absorption 3D printer enabling to simultaneously print a plurality of voxels.

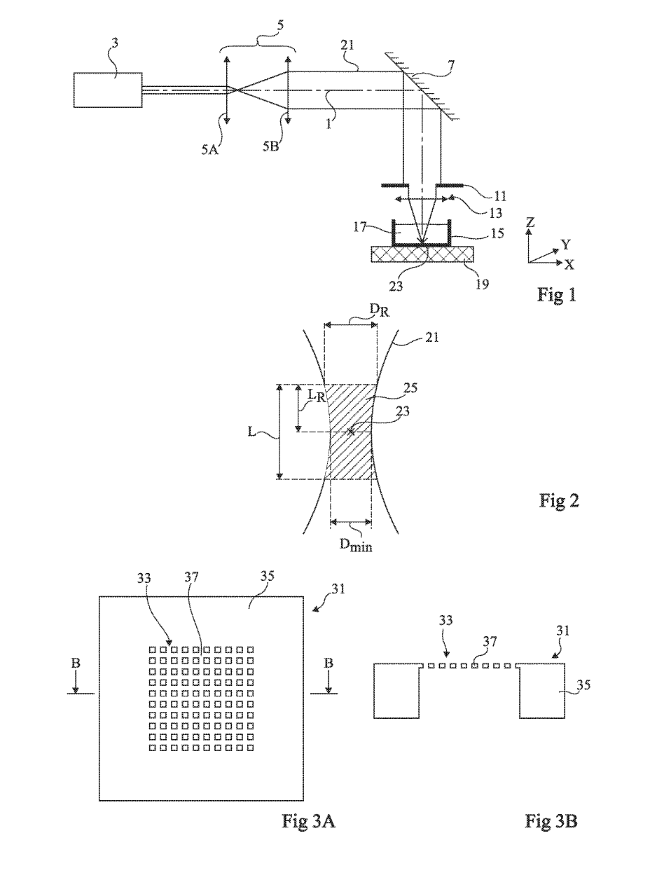

The printer comprises, on its optical axis 1, same elements as the 3D printer of FIG. 1, that is, a laser source 3, a beam magnifier 5, a planar mirror 7, a diaphragm 11, and a focusing lens 13. The printer further comprises means 51 for generating, preferably simultaneously, a number k of laser beams 53 forming an array of irradiation beams. The k beams of the array are focused by lens 13 into an array of k points 23 in a photosensitive material 17 contained in a tray 15 resting on an XYZ table 19.

Thus, an array of k voxels corresponding to the array of k focusing points may be formed for each irradiation of material 17. Due to the fact that k voxels of an array are simultaneously formed for each irradiation, this results in a decrease by a factor k in printing times as compared with a printing method where a single voxel is formed for each irradiation.

As an example, to simultaneously generate k laser beams of an array focused into an array of k points, means such as arrays of microlenses, diffractive phase masks, phase and/or amplitude modulation liquid crystal matrixes, and digital micromirror devices, may be used. Various examples of these means are described in literature, particularly in:
“White-light-modified Talbot array illuminator with a variable density of light spots” of E. Tajahuerce et al., Jul. 10, 1998, Applied Optics, volume 37, number 20;
“Binary surface-relief gratings for array illumination in digital optics” of A. Vasara et al., Jun. 10, 1992, Applied Optics, volume 31, number 17; and
“Multiple-spot parallel processing for laser micronanofabrication” of J. Kato et al., 2005, Applied Physics Letters 86.

For example, by using an appropriate phase mask associated with a 1-Watt and 130-kHz amplified nanosecond pulsed laser, more than 1,000 voxels may be simultaneously formed within a few milliseconds in a commercial resin.

According to an embodiment, k identical bricks are simultaneously manufactured from a given array of k focusing points. To achieve this, the k focusing points of the array are selected so that each corresponds to a given position (for example, the upper left-had corner) of k different bricks. The k bricks are constructed by displacing tray 15 between each irradiation until all the voxels forming the k bricks are formed.

Thus, to simultaneously manufacture k bricks, the conditions of the focusing of the k laser beams 53 of the array are only determined once, and the displacements of tray 15 are determined very simply from the offsets between voxels of one of the bricks to be printed. This results in a decrease in the times of calculation of the focusing condition and of the displacements of tray 15, and thus in a decrease in the printing time. As an example, the forming of a surface area of one square millimeter from bricks having a one-millimeter side length comprising square hollow portions having an approximate ten-micrometer side length by simultaneously printing k=2,401 voxels for each irradiation only requires 10 minutes while with prior art methods, a printing time greater than 2,500 hours is necessary to print a same surface area of a continuous layer of voxels.

It may be provided to modulate the intensities of the k beams of an array, for example with a liquid crystal array. On the one hand, it may be provided to homogenize the intensity of each beam at the level of the corresponding focal point so that all the voxels simultaneously formed during an irradiation have identical dimensions. On the other hand, during an irradiation, it may be provided to blank some of the k beams of the array. In this case, no voxel is formed at the level of the focal points corresponding to the blanked beams. This for example enables to print a portion only of the voxels of a brick, particularly in the vicinity of the surface of a given volume so that the contours of the brick follow this surface.

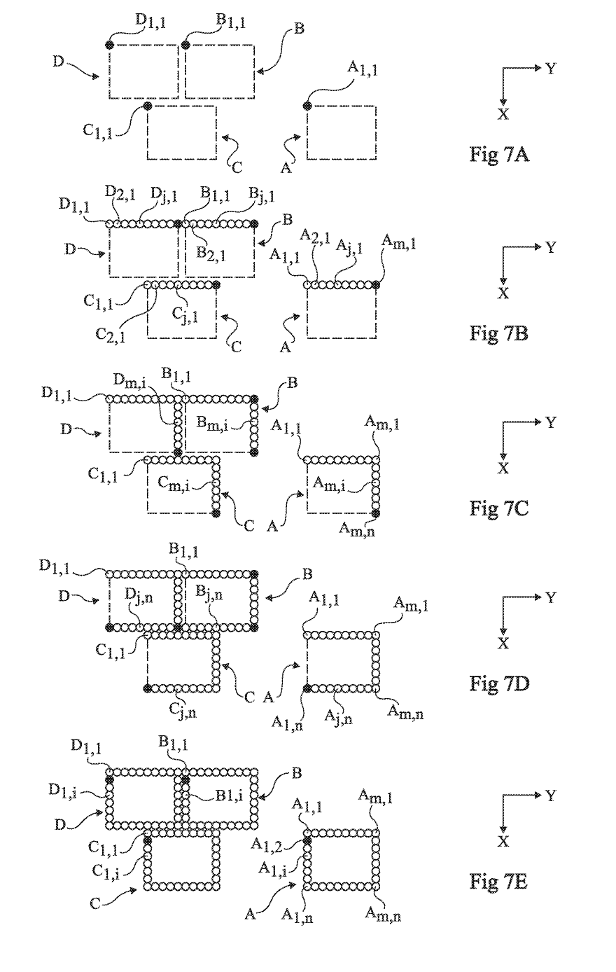

FIGS. 7A to 7E are top views of material 17 of FIG. 6 illustrating successive steps of such an embodiment of a 3D printing method. In this example, k=4 and four bricks of the type of brick 41A of FIG. 5A are manufactured. In FIGS. 7A to 7E, the voxels of an array which have been simultaneously printed during the last irradiation have been shown with full disks, the previously-printed voxels have been shown with an empty circle, and the contours of k bricks A, B, C, and D to be printed have been shown with dotted lines. In these drawings, the voxels are not to scale and, in practice, each brick comprises a number of voxels much larger than that shown in the drawings.

In FIG. 7A, the focusing conditions of each beam of an array of k laser beams 53 of a 3D printer of the type in FIG. 6 have been selected to obtain a given array of k focusing points 23 in material 17, each focusing point 23 corresponding, in this example, to the upper left-hand corner of each of the k bricks A, B, C, and D. The irradiation of material 17 then enables to simultaneously form voxels A_{1,1}, B_{1,1}, C_{1,1} and D_{1,1}. In this example, the k focusing points 23 belong to a same XY plane.

In FIG. 7B, without modifying the given array of the k focusing points, tray 15 is displaced in the XY plane by a quantity corresponding to the interval between voxel A_{1,1} and its neighboring voxel A_{2,1} on the upper side of brick A. Material 17 is then irradiated to form voxel A_{2,1}. During the forming of voxel A_{2,1}, voxels B_{2,1}, C_{2,1}, and D_{2,1} of bricks B, C, and D are simultaneously formed. The displacement and irradiation steps are then repeated until each of the m voxels A_{j,1}, B_{j,1}, C_{j,1}, and D_{j,1} has been formed on the upper side of bricks A, B, C, and D, j being an integer in the range from 1 to m.

In FIG. 7C, the displacement and irradiation steps are repeated until each of the n voxels A_{m,i}, B_{m,i}, C_{m,i}, and D_{m,i} have been formed on the right-hand side of bricks A, B, C, and D, i being an integer in the range from 1 to n.

In FIG. 7D, the displacement and irradiation steps are repeated until each of the m voxels A_{j,n}, B_{j,n}, C_{j,n}, and D_{j,n} have successively been formed on the lower side of bricks A, B, C, and D.

In FIG. 7E, the displacement and irradiation steps are repeated until each of n−1 voxels A_{1,j}, B_{1,j}, C_{1,j}, and D_{1,j} have successively been formed, stopping at voxels A_{2,1}, B_{2,1}, C_{2,1}, and D_{2,1}. All the voxels A_{i,j}, B_{i,j}, C_{i,j}, and D_{i,j} from which bricks A, B, C, and D are formed are finally obtained.

Preferably, in a portion of the object to be printed which does not require a maximum resolution, all the bricks from which a layer of this portion is formed are simultaneously manufactured. In the case where number k of beams of an array is not sufficient to form all the bricks from which a layer is formed, the other bricks are formed from one or a plurality of new arrays of k focusing points 23.

To print a next layer of the object, tray 15 is displaced along axis Z for example by a quantity smaller than or equal to height L of a voxel.

A method of 3D printing of portions of an object which do not require a high printing resolution from hollow voxel bricks and an embodiment comprising simultaneously forming k bricks have been previously described. Various alteration and modifications will occur to those skilled in the art, among which the following can be mentioned.
The object to be printed may comprise more than two areas of different resolutions. In this case, the volumes of the portions of this object which do not require a high printing resolution are broken down from blocks 39 of different dimensions.
Any type of 3D printing method based on successive irradiations of a photosensitive material may be used, and not only two-photon absorption 3D printing methods.
The dimensions and the shape of the blocks, of the bricks, and of the voxels may be modified. For example, round or hexagonal (honeycomb) bricks may be printed, the displacements of focusing point(s) 23 in material 17 then being adapted to the shapes of these bricks.
Between each irradiation of material 17, focusing point(s) 23 may be displaced in this material by a quantity greater than the interval between two neighboring voxels.
The displacements of focusing point(s) 23 in material 17 may be performed by control of the settings of the optical system of the 3D printer rather than by displacement of tray 15 containing material 17 relative to the optical system of the 3D printer.
The portions of high resolution may be formed layer by layer before or after the printing, in each layer, of bricks corresponding to portions of lower resolution. If the type of photosensitive material allows it, the high-resolution portions may be printed before or after the printing of the assembly of one or a plurality of portions of lower resolution.

In the case of the embodiment comprising simultaneously printing a plurality of bricks, the following variations and modifications can be mentioned.
Instead of printing k voxels of k distinct bricks, a given array of k focusing points 23 may be selected so that the k points 23 of the array correspond to a same brick or to a small number of bricks.
Instead of simultaneously manufacturing a plurality of bricks of a same layer, a plurality of bricks may be simultaneously manufactured in different layers by selecting a given array of k focusing points 23 distributed in a plurality of XY planes.
The k laser beams 53 of an array may be generated and focused by any type of known means rather than with means 51 described in FIG. 6.

Various embodiments with different variations have been described hereabove. It should be noted that those skilled in the art may combine various elements of these various embodiments and variations without showing any inventive step.

1. A 3D printing method, where elementary volumes, or voxels, of a material are sequentially transformed by irradiation, comprising the steps of:
breaking down the volume of a portion of an object to be printed which does not require a maximum resolution into identical blocks;
for the printing, associating with each block a brick of same contour comprising hollow portions; and
carrying out a succession of irradiations to print the voxels of the bricks, each irradiation providing an array of irradiation beams focused into an array of points distributed in the material in the same way for two successive irradiations, the array of points being offset in the material between two successive irradiations.

2. The method of claim 1, wherein, during certain irradiations, certain beams are inhibited.

3. The method of claim 1, wherein the array of points is offset in the material by the displacement of a tray filled with the material.

4. The method of claim 1, wherein the array of points is offset in the material by a quantity smaller than the dimensions of a voxel.

5. The method of claim 1, wherein the array of points corresponds to an array of voxels, each of which is located at a given position of a different brick.

6. The method of claim 1, wherein the array of points corresponds to an array of voxels, each of which is located at a given position of a same brick.

7. The method of claim 1, wherein the transformation of a voxel results from a photochemical reaction induced by absorption of two photons.

8. The method of claim 1, wherein the dimensions of said blocks are at least 100 times larger than those of the voxels.

9. The method of claim 1, wherein the portion which does not require the maximum resolution has dimensions at least 100 times larger than the maximum resolution.
